(19) United States
(12) Patent Application Publication
(10) Pub. No.: US 2024/0367033 A1
(43) Pub. Date: Nov. 7, 2024

(54) CONTROLLING GAME STATE

(71) Applicant: Sony Interactive Entertainment Inc., Tokyo (JP)

(72) Inventors: Maria Chiara Monti, London (GB); Lawrence Martin Green, London (GB); Pavel Rudko, London (GB)

(73) Assignee: Sony Interactive Entertainment Inc., Tokyo (JP)

(21) Appl. No.: 18/638,770

(22) Filed: Apr. 18, 2024

(30) Foreign Application Priority Data
May 4, 2023 (GB) 2306608.7

(51) Int. Cl. A63F 13/212; A63F 13/213; A63F 13/215; A63F 13/52; A63F 13/54; A63F 13/67; A63F 13/79

(52) U.S. Cl. CPC A63F 13/212; A63F 13/213; A63F 13/215; A63F 13/52; A63F 13/54; A63F 13/67; A63F 13/79

(57) ABSTRACT

An entertainment device comprising processing circuitry to identify a game to be processed and process a game state of the game, and communication circuitry to receive activity data recorded by at least one mobile device, the activity data relating to one or more activities performed by a user. The processing circuitry is configured to control, in dependence on the received activity data, at least one aspect of the game state.

### BACKGROUND

The present technique relates to the field of video games.

An entertainment system creates game experiences for a user (for example, by processing games to be played by the user). Typically, the game experiences are generated by the entertainment system based on selections made by a user—for example, a user may select a particular game to play. The game experiences are typically independent of a user's experiences while not using the entertainment system (for example, a user's experiences over the course of a day do not typically influence the generation of game experiences by the entertainment system).

Examples described herein aim to provide techniques which allow game experiences to be generated which reflect, complement or contrast a user's experiences in the real world.

The present technique is defined by the claims.

Further respective aspects and features of the disclosure are defined in the appended claims.

### BRIEF DESCRIPTION OF THE DRAWING

Embodiments of the present disclosure will now be described by way of example with reference to the accompanying drawings, in which:

FIGS. 1 and 2 show examples of entertainment systems;

FIG. 3 is a flow diagram showing an example method for processing a game;

FIG. 4 shows another example of an entertainment system;

FIG. 5 is a flow diagram showing another example method for processing a game;

FIG. 6 is a flow diagram showing an example method for determining whether to complement or contrast a user's excitement level;

FIG. 7 is a flow diagram showing an example method for determining a user's excitement level;

FIG. 8 shows another example of an entertainment system;

FIG. 9 is a flow diagram showing an example method for classifying games;

FIG. 10 is a flow diagram showing an example method for selecting a game;

FIG. 11 shows another example of an entertainment system;

FIG. 12 shows an example of a welcome screen;

FIG. 13 shows another example of an entertainment system;

FIG. 14 is a flow diagram showing an example method for generating augmented reality (AR) content.

### DETAILED DESCRIPTION

For clarity of illustration, elements illustrated in the figures have not necessarily been drawn to scale. Further, where considered appropriate, reference numerals have been repeated among the figures to indicate corresponding or analogous elements.

Methods and systems are disclosed for processing games. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

In the present application, the words “comprising at least one of . . . ” are used to mean that any one of the following options or any combination of the following options is included. For example, “at least one of: A; B and C” is intended to mean A or B or C or any combination of A, B and C (e.g. A and B or A and C or B and C or A and B and C).

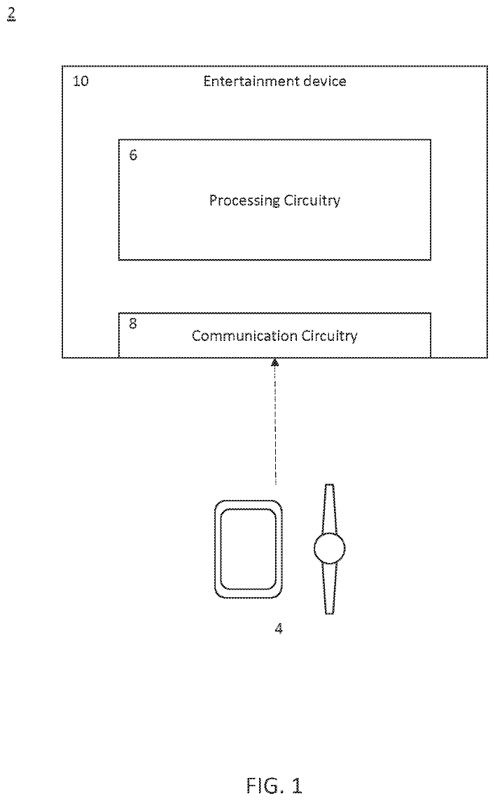

FIG. 1 illustrates an entertainment system 2 comprising an entertainment device (10) and at least one mobile device 4. The at least one mobile device can be any device associated with a user, which is capable of recording activity data relating to one or more activities performed by a user. For example, the mobile device can include a device which can be held (such as a mobile phone (e.g. smartphone) or tablet) and/or a device which can be worn (such as a wearable device, e.g. a smartwatch, glasses or other wearable device).

The entertainment device 10 comprises processing circuitry 6 to identify a game to be processed, and to process a game state of the game. For example, the processing circuitry may obtain, from a storage structure (not shown, but this could be internal storage or external storage), game data of a game, and process the game data in dependence on user input data to generate a game experience for the user.

The entertainment device 10 also includes communication circuitry 8 to receive the activity data recorded by the at least one mobile device. For example, the communication circuitry 8 could receive the activity data via a direct wired or wireless connection between the communication circuitry 8 and the at least one mobile device 4. Alternatively, the communication circuitry 8 may receive the activity data via an indirect route—for example, the activity data may be uploaded, via the internet, to a cloud storage platform, and the communication circuitry 8 may receive the activity data from the cloud storage platform over the internet. The activity data may be accompanied by information identifying the user.

The processing circuitry 6 is responsive to the activity data being received to control, in dependence on the received activity data, at least one aspect of the game state. Examples of aspects of the game state that can be controlled are set out below but, in general, controlling one or more aspects of the game state in dependence on the user's activity data provides a mechanism for tailoring game experiences in dependence on a user's real-life experiences. For example, the processing circuitry can be configured to control the at least one aspect of the game state to complement or contrast the one or more activities indicated by the activity data.

Examples of activity data which can be received by the communication circuitry 8 include, for example: biometric data of a user, such as heart rate data, sleep data, blood pressure data, body temperature, etc.; activity records indicative of physical activities performed by the user—for example, these could include a step count, a number of active minutes recorded by the mobile device, a number of workouts recorded, a number of minutes of meditation recorded, etc.; images captured by a camera of the at least one mobile device; and audio recorded by a microphone of the at least one mobile device.

It will, of course, be appreciated that these are just some examples of activity data which can be recorded by a mobile device 4 and provided to the communication circuitry 8, and that any other form of activity data indicative of activities performed by the user may be used.

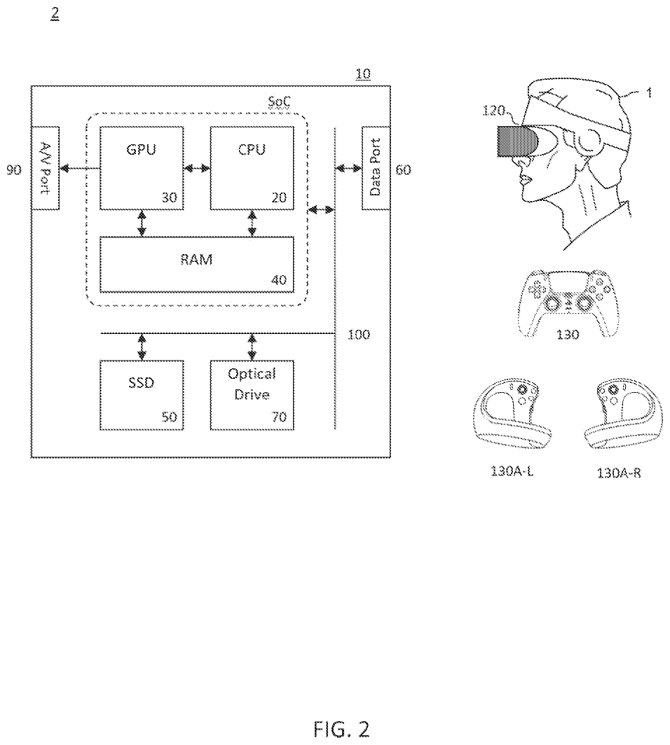

Referring to FIG. 2, an example of an entertainment system 10 is a computer or console such as the Sony® PlayStation 5® (PS5).

The entertainment system 10 comprises a central processing unit (CPU) 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5. The processing circuitry 6 described above may comprise one or both of the CPU 20 and the GPU 30.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

The communication circuitry 8 described above may comprise one or more of the data ports 60, and/or the optical drive 70 and/or the A/V ports 90.

An example of a device for displaying images output by the entertainment system is a head mounted display ‘HMD’ 120, such as the PlayStation VR 2 ‘PSVR2’, worn by a user 1. An HMD 120 is also an example of a wearable mobile device 4.

Where components are not integrated, they may be connected as appropriate either by a dedicated data link or via a bus 100.

Interaction with the system is typically provided using one or more handheld controllers (130, 130A), such as the DualSense® controller (130) in the case of the PS5, and/or one or more VR controllers (130A-L,R) in the case of the HMD.

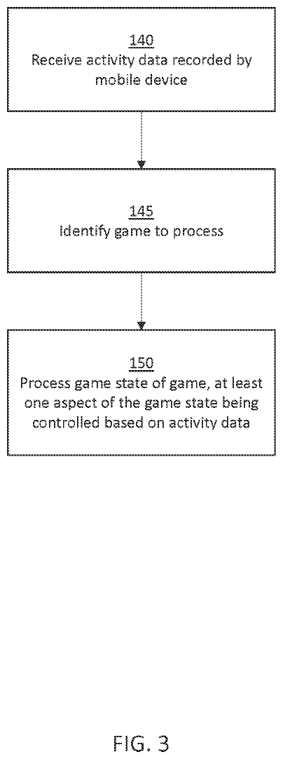

Turning now to FIG. 3, this figure is a flow diagram illustrating an example of a method in which: activity data, recorded by at least one mobile device, is received 140. The activity data relates to one or more activities performed by a user; a game to be processed is identified 145; and a game state of the game is processed 150, at least one aspect of the game state being controlled in dependence on the received activity data.

There are many ways in which the processing circuitry 6 may use the activity data to control the at least one aspect of the game state. In some examples, the processing circuitry 6 is configured to determine, in dependence on the activity data, an excitement level for the user, and to control, based on the excitement level, the at least one aspect of the game state.

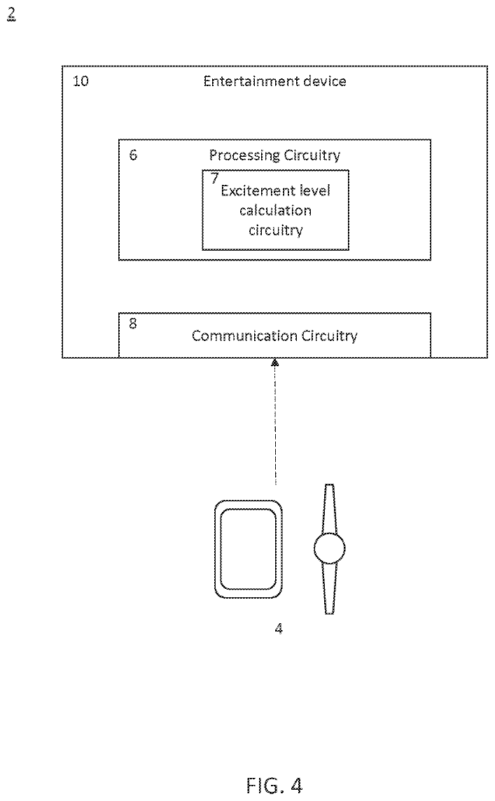

For example, FIG. 4 shows a particular example of the entertainment system 2 in which the processing circuitry 6 comprises excitement level calculation circuitry 7 to calculate the excitement level.

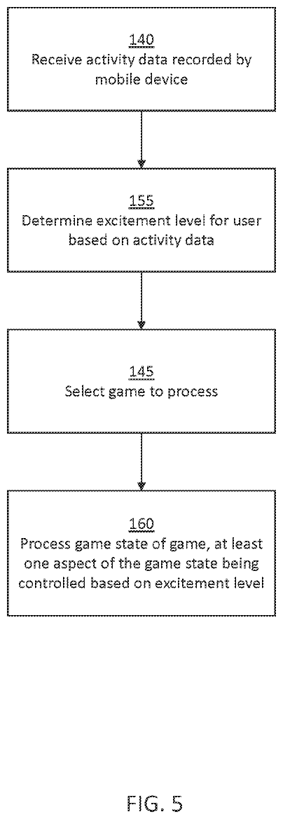

This is also illustrated in FIG. 5, which shows a particular example of a method for processing a game. FIG. 5 includes, in addition to steps 140 and 145 shown in FIG. 3, a step 155 of determining the excitement level for the user based on the activity data. FIG. 5 also includes a step 160 of processing the game state of the game, wherein at least one aspect of the game state is controlled based on the excitement level. Step 160 is a particular example of step 150 as shown in FIG. 3.

The processing circuitry 6 may control the at least one aspect of the game state to complement or to contrast the excitement level determined, for the user, by the excitement level calculation circuitry 7. For example, the communication circuitry 8 may be configured to receive input data indicative of a user input, and the processing circuitry 6 may be configured to determine, based on the input data, a selection made by a user. The processing circuitry 6 may then determine, based on the selection made by the user, whether to modify the processing of the game to complement the excitement level or to contrast the excitement level. For example, a user may select—e.g. by pressing a button on a controller—an option to indicate whether they would prefer a complementary experience (e.g. a gaming experience which complements the level of excitement experienced by the user) or a contrasting experience (e.g. a gaming experience which contrasts the level of excitement experienced by the user). An input indicative of the user's selection may be received (e.g. from the controller) by the communication circuitry 8, and the processing circuitry may determine the user selection based on the received input data. The processing circuitry 6 may then decide whether to provide a complementary or contrasting gaming experience based on the user's selection. Note that other factors could also be considered in addition to considering the user's selection.

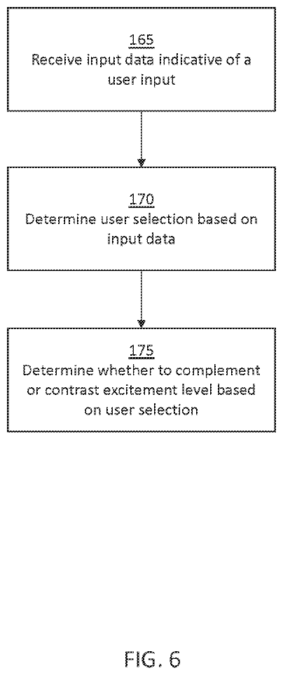

FIG. 6 shows an example of a method in which a user selection is used to determine whether to complement or contrast the excitement level determined by the processing circuitry. The method shown in FIG. 6 includes a step 165 of receiving input data indicative of a user input. The input data is then used to determine 170 a user selection, and this user selection is used to determine 175 whether to generate a complementary or contrasting gaming experience.

In other examples, the decision of whether to provide a contrasting or complementary gaming experience may not be dependent on a user input. For example, the processing circuitry could instead determine whether to provide a contrasting or complementary experience based on the excitement level. For example, the excitement level could be selected from a number of options such as “slightly exciting”, “very exciting”, “slightly relaxing” and “very relaxing”. The processing circuitry could, in some examples, be configured to provide a complementary experience when the excitement level is “slightly exciting” or “slightly relaxing”, and a contrasting experience when the excitement level is “very exciting” or “very relaxing”.

Some of the examples described above consider an excitement level (which may also be referred to as a stress level) calculated for the user. For example, this could be a value or rating indicative of a level of stress or excitement that a user has experienced over a given period of time (e.g. over the course of the current day). There are many ways that such an excitement level could be calculated. In some examples, the excitement level can be calculated based on heart rate data (an example of biometric data, which is an example of activity data) recorded by the mobile device.

For example, the heart rate data could be an indication of a user's average heart rate over a given period of time (e.g. over the course of the day). The heart rate data could alternatively (or additionally) indicate a number of times that the user's heart rate exceeded a given threshold over the given period of time. The average heart rate and/or the number of times the given threshold was exceeded can then be compared to a predetermined threshold, and the result of the comparison can be used to determine the excitement level.

For example, in the following example the average heart rate is used, and the predetermined threshold is 100 bpm (beats per minute):

| Average | Excitement |
|---|---|
| Heart Rate | Level |
| >=100 bpm | Low |
| <100 bpm | High |

In the following example, the number of times that the user's heart rate exceeded a given threshold is used. The given threshold is 100 bpm, the given period of time is one day, and the predetermined threshold is 5 times.

| Number of times | |
|---|---|
| exceeding 100 | Excitement |
| bpm in 1 day | Level |
| 0-5 times | Low |
| 6+ times | High |

It will be appreciated that the specific thresholds and time periods used above are just examples, and the actual thresholds and time periods used may differ from those used above. It will also be appreciated that, while the above examples assume that two excitement levels are defined (“Low” (e.g. relaxed) and “High” (e.g. excited/stressed)), the number of excitement levels is not limited to two.

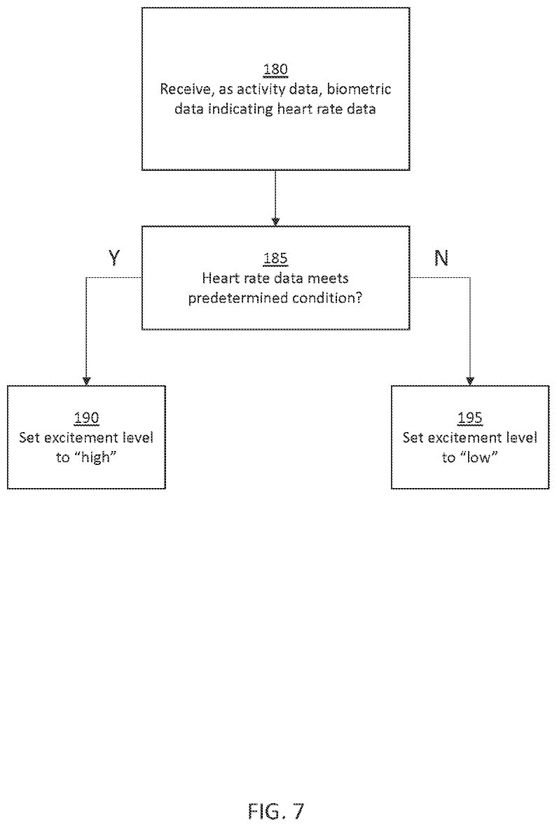

FIG. 7 is a flow diagram illustrating the use of heart rate data to determine an excitement level. In the method of FIG. 7, biometric data indicating the heart rate data is received 180, and it is determined 185 whether the heart rate data meets a predetermined condition (e.g. this condition could be that the average heart rate exceeds a predetermined threshold, or that the number of times the heart rate exceeded a given threshold is greater than a given number). If (“Y” branch) the predetermined condition is met, the excitement level is set 190 to “high”, whereas if (“N” branch) the predetermined condition is not met, the excitement level is set 195 to “low”.

The processing circuitry 6 of the entertainment device 10 is configured to control at least one aspect of the game state in dependence on the activity data. The “at least one aspect of the game state” (which can be one aspect of the game state or more than one aspect of the game state) can include any of a number of different aspects. For example, the at least one aspect could be any one or more of: the selection of the game to be processed; the selection of a difficulty level of the game; generation of audio to be played during playing of the game; and generation of images to be displayed during playing of the game.

As a particular example, the selection of the game to be processed could be controlled so that a more exciting game is selected to complement a more exciting day (indicated by the activity data) or to contrast a more relaxing day, or a more relaxing game could be selected to complement a more relaxing day or to contrast a more exciting day.

As another example (which could, optionally, by applied in combination with the above example), the selection of the difficulty level could be controlled such that a higher difficulty is set to complement a more exciting day or to contrast a more relaxing day, or a lower difficult can be set to complement a more relaxing day or to contrast a more exciting day.

As another example (which could, optionally, by applied in combination with one or both of the above examples), the generation of the audio to be played could be controlled such that louder and/or higher-tempo audio is selected to complement a more exciting day or to contrast a more relaxing day, while quieter and/or lower-tempo audio is selected to complement a more relaxing day or to contrast a more exciting day. Other ways of controlling the audio could involve adjusting the complexity of the audio—for example, the number of different sounds/instruments overlaid on one another could be adjusted (for example, to make the audio more relaxing or exciting to listen to). Alternatively, an entirely different soundtrack could be used depending on the activity data. The audio could also be controlled to determine whether NPCs in a game have voices, or rely solely on subtitles.

As another example (which could, optionally, by applied in combination with one or more of the above examples), the generation of images could be controlled to adjust (for example) the visual business of images on the screen. For example, some users may perceive a more intricate image (e.g. with more visual components) as more stressful to look at, while a simpler (e.g. clearer) image is more relaxing to look at. Hence, the “business” or level of clutter in an image could be controlled based on the user's activity data. Another possibility is to make use of images captured by the mobile device and to integrate these or similar images into the game being processed. For example, if a user has visited a beach and hence their mobile device has captured (as activity data) several images of the beach, the processing circuitry could change the visual setting for a game to be a beach.

Returning to the example of selection of a game to be processed, note that this could be selected from amongst a plurality of games. In particular, the processing circuitry 6 may be configured to select the game to be processed in dependence on the activity data recorded by the at least one mobile device and a classification of each of the plurality of games.

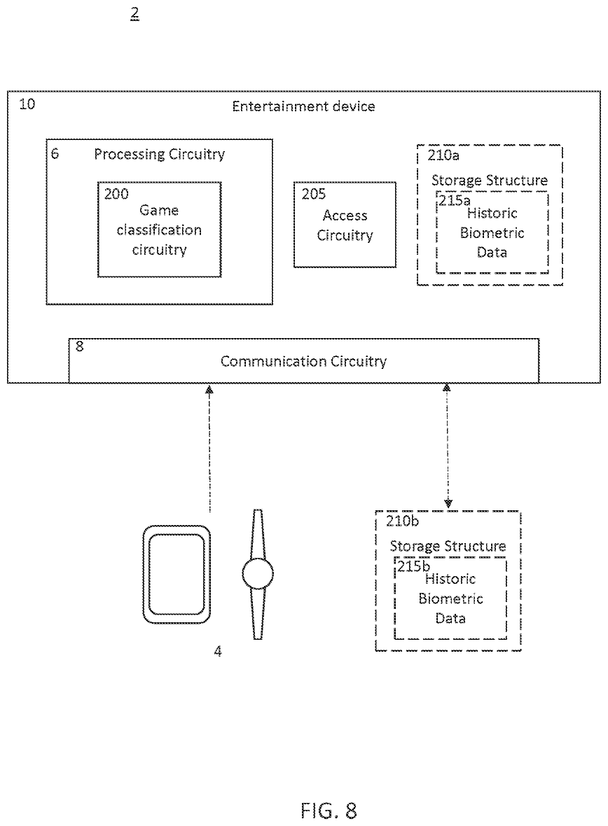

FIG. 8 shows an example of how the entertainment system 2 can be adapted to classify a plurality of games. Note that the circuitry shown in the entertainment device 10 of FIG. 8 could also be included in the entertainment devices 10 discussed in any of the above examples.

As shown in FIG. 8, the entertainment device 10 may comprise access circuitry 205 to obtain, from a storage structure 210, historic biometric data 215 associated with each of the plurality of games. The storage structure 210 could be internal storage circuitry 210a of the entertainment device 10, or it could be external storage circuitry 210b, accessible to the access circuitry 205 via the communication circuitry 8.

The processing circuitry 6 in this example is configured to classify each of the plurality of games in dependence on the historic biometric data associated with that game. For example, the processing circuitry 6 in FIG. 8 comprises game classification circuitry 200 to classify games based on historic biometric data.

The historic biometric data 215a, 215b may be biometric data gathered from players during playing each of the plurality of games. For example, this could include biometric data collected from multiple different players playing the game in the past. The historic biometric data could also (or instead) include biometric data collected from the current user (e.g. the user whose current biometric data is being used to control at least one aspect of the game state) a previous time they played the game.

For example, the historic biometric data may comprise, for each of the plurality of games, historic heart rate data indicative of an average change in heart rate for one or more players playing the game. This data can be used to classify the games—for example, the processing circuitry may be configured to classify, in response to the average change in heart rate indicating an increase in heart rate, a given game as an exciting game. On the other hand, the processing circuitry may be configured to classify, in response to the average change in heart rate indicating a decrease in heart rate, the given game as a relaxing game. Hence, historic biometric data such as historic heart rate data can be used to classify games.

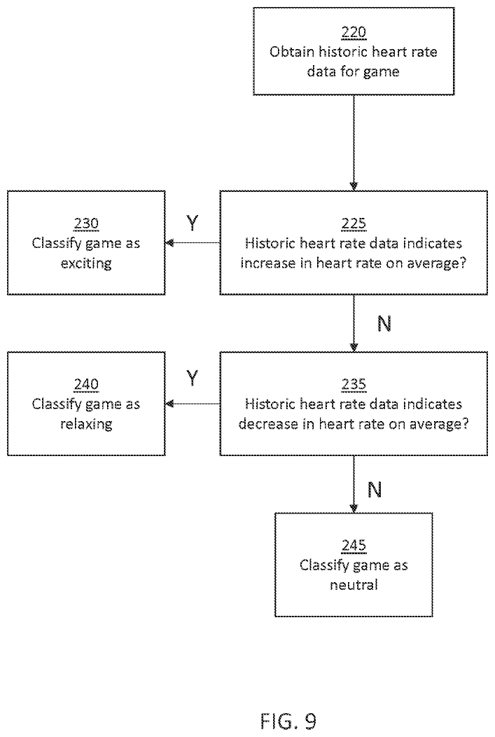

FIG. 9 is a flow diagram showing an example of a method for classifying games based on historic heart rate data. In this example, the processing circuitry may classify at least one of the plurality of games as one of: an exciting game; a neutral game; or a relaxing game.

As shown in FIG. 9, historic heart rate data for a given game is obtained 220, and it is determined 225 whether the historic heart rate data indicates an increase in heart rate on average for users playing the given game. If the historic heart rate data does indicate an increase (“Y” branch), the game is classified 230 as “exciting”. On the other hand, if the historic heart rate data does not indicate an average increase in heart rate (“N” branch), it is determined 235 whether the historic heart rate data indicates a decrease on average. If the historic heart rate data does indicate a decrease on average (“Y” branch), the game is classified 240 as “relaxing”. Otherwise (“N” branch), the game is classified 245 as “neutral”.

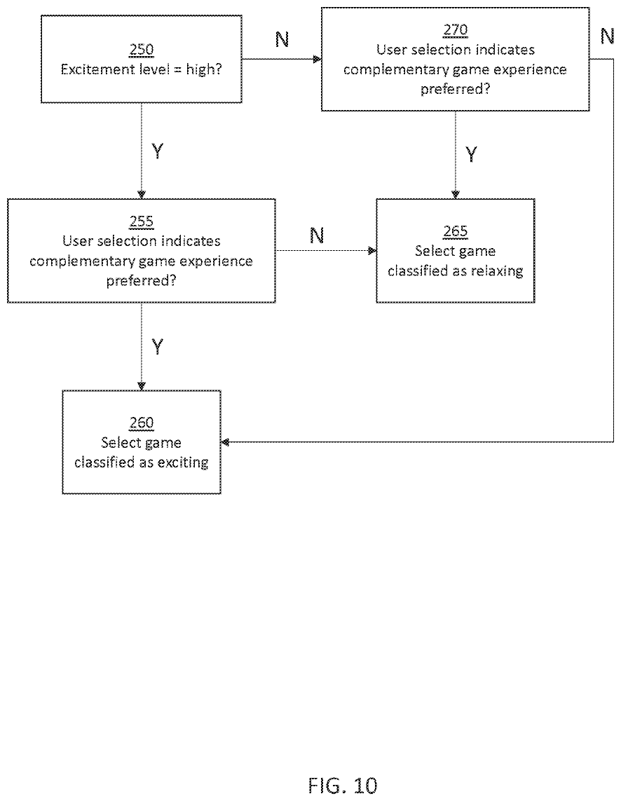

FIG. 10 is a flow diagram illustrating an example of a method in which a user's excitement level and the classification of each of a plurality of games are used to select a game to be processed. In this method, it is determined 250 whether the user's excitement level is “high”, and it is also determined 255, 270 whether a selection made by the user indicates that a complementary game experience is preferred.

If the user's excitement level is high (“Y” branch from step 250) and the user selection indicates that a complementary game experience is preferred (“Y” branch from step 255), a game classified as “exciting” is selected 260.

If the user's excitement level is high (“Y” branch from step 250) and the user selection indicates that a complementary game experience is not preferred (“N” branch from step 255—for example, the user selection may instead indicate that a contracting experience would be preferred), a game classified as “relaxing” is selected 265.

If the user's excitement level is not high (“N” branch from step 250—for example, the excitement level could be “low”) and the user selection indicates that a complementary game experience is preferred (“Y” branch from step 270), a game classified as “relaxing” is selected 265.

If the user's excitement level is not high (“N” branch from step 250) and the user selection indicates that a complementary game experience is not preferred (“N” branch from step 270), a game classified as “exciting” is selected 260.

Hence, by implementing the methods of FIGS. 9 and 10, which may be performed using the circuitry shown in FIG. 8, it is possible to tailor the selection of the game to be processed to the user's calculated excitement level.

As explained above, the selection of the game to play is just one example of the at least one aspect of the game state to be controlled in dependence on the activity data captured by the mobile device(s) 4. Another example is the generation of images to be displayed during playing of the game. For example, the images used in the background or scenery of games may be controlled, the brightness or colours displayed during the playing of the game may be controlled, the frame rate of moving images may be controlled, or any other aspect of image generation associated with processing of the game may be controlled.

The image generation may be controlled on the basis of any activity data provided by the mobile device(s) 4. However, in a particular example, the activity data comprises information indicative of images captured by a camera of the at least one mobile device, and the processing circuitry is configured to control, in dependence on a result of image classification of the images captured by the camera of the at least one mobile device, the generation of the images to be displayed during playing of the game. For example, the activity data received from the mobile device(s) 4 could be information about the classification of the images captured by the device (for example, the images may be classified by image classification circuitry on the device). Alternatively, the activity data could include the captured images themselves, and the processing circuitry 6 of the entertainment device 4 may be arranged to classify the images.

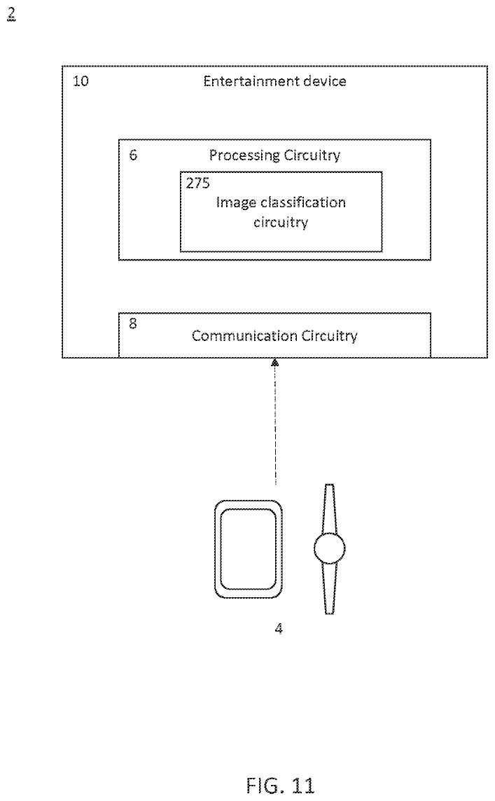

For example, FIG. 11 shows an example of how the entertainment system 2 can be adapted to classify images received from one or more mobile devices 4. Note that the circuitry shown in the entertainment device 10 of FIG. 11 could also be included in the entertainment devices discussed in any of the above examples.

In the example shown in FIG. 11, the processing circuitry 6 comprises image classification circuitry 275, which is configured to perform image processing to classify images received from the at least one mobile device 4. Once the images have been classified (for example, by identifying common features across all of the images), information about the classification can be used to control one or more aspects of the game state—these aspects may include the generation of images in association with the game.

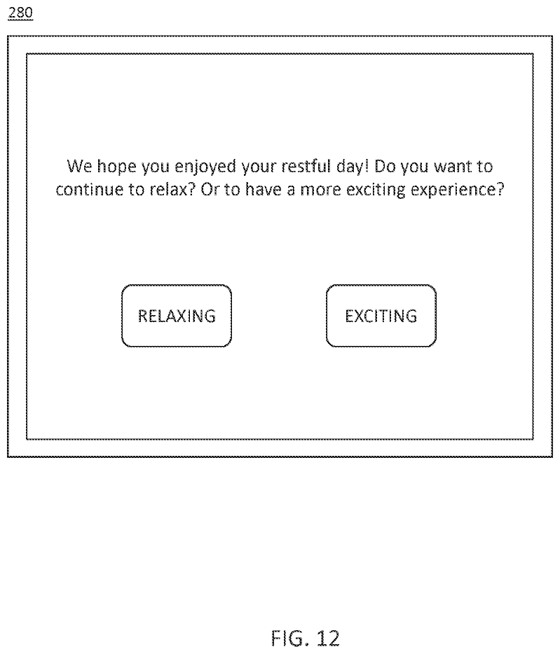

In addition to controlling at least one aspect of game state, the processing circuitry 6 may be configured to generate, in dependence on the activity data, a welcome screen for display in response to the entertainment device being powered on. FIG. 12 shows one example of a welcome screen 280 that could be generated based on the activity data. In this example, the screen shows the following message, in response to determining, from the activity data, that the user had a relaxing day: “We hope you enjoyed your restful day! Do you want to continue to relax? Or to have a more exciting experience?”. In this particular example, the welcome screen also the user with two selectable options: “Relaxing” and “Exciting”. In this way, the welcome screen can also provide an opportunity for the user to indicate whether they would prefer a complementary game experience (“Relaxing”) or a contrasting game experience (“Exciting”).

As mentioned above, the one or more mobile devices 4 can take any of a number of forms, including a smartphone, a smart watch or other wearable device or fitness tracker, and smart glasses.

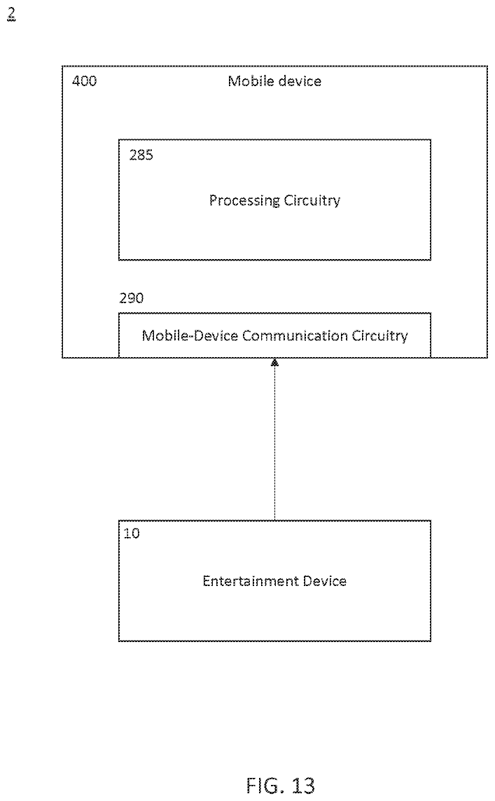

FIG. 13 shows a particular example of an AR-capable mobile device 400 that is capable of displaying augmented reality (AR) images (e.g. images that include elements of the real world as well as virtual elements). For example, the mobile device 400 could be an augmented reality headset (e.g. AR glasses, which may display a holographic image over part of a lens, or a virtual reality (VR) headset which is capable of displaying AR images). Alternatively, the mobile device 400 could be a smartphone with a camera, the smartphone being capable of generating AR images based on images captured by the camera, and displaying the AR images on the smartphone's screen.

Whatever form the AR-capable mobile device 400 takes, it comprises processing circuitry 285 to generate AR images for display. The device 400 may also comprise a display screen (not shown) for displaying those images—alternatively, the images may be provided to some other device via mobile-device communication circuitry 290.

The mobile-device communication circuitry 290 also receives, from the entertainment device 10, game information associated with a game played by the user. For example, the game information could include images taken from the game, the identity of the game, or any other details relating to the game. The processing circuitry 285 then uses the game information to generate AR images for display. In this way, a user's experiences in a game can be integrated into an AR display, so that a user's real-world experiences reflect their in-game experiences.

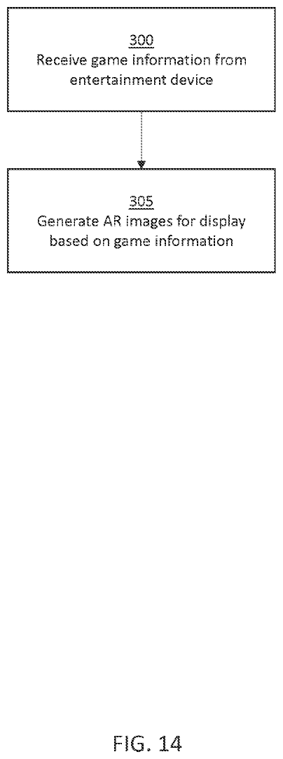

FIG. 14 shows an example of a method for generating AR images based on game information. As shown in the figure, the method includes a step 300 of receiving game information from a device, and a step 305 of generating AR images for display based on the game information.

The use, by a mobile device 400, of game information to generate AR images may be implemented in combination with the other techniques described above. For example, the entertainment system 2 could include an entertainment device 10 as described in any of the above examples (e.g. an entertainment device capable of receiving activity data from at least one mobile device 4—which may or may not include the AR-capable mobile device 400—and using this to control an aspect of the game state) in addition to including the AR-capable mobile device 400 shown in FIG. 13. However, it is also possible for the AR-capable mobile device 400 to be provided in a different entertainment system 2, in which the entertainment device 10 is not necessarily capable of controlling at least one aspect of game state in dependence on activity data.

Any of the examples described above may be provided in combination with any of the other examples provided. Moreover, any of the methods described above can be provided in the form of a computer program (e.g. a computer program comprising instructions which, when executed by a computer, cause the computer to perform one or more of the above methods). The computer program may be stored on a computer-readable storage device, which may be transitory or non-transitory.

Example(s) of the present technique are defined by the following numbered clauses:

1. An entertainment device comprising: processing circuitry to identify a game to be processed, and to process a game state of the game; and communication circuitry to receive activity data recorded by at least one mobile device, the activity data relating to one or more activities performed by a user, wherein the processing circuitry is configured to control, in dependence on the received activity data, at least one aspect of the game state.
2. The entertainment device of clause 1, wherein the processing circuitry is configured to control the at least one aspect of the game state to complement or contrast the one or more activities indicated by the activity data.
3. The entertainment device of clause 1 or clause 2, wherein the activity data comprises information indicative of at least one of: biometric data of a user; activity records indicative of physical activities performed by the user; images captured by a camera of the at least one mobile device; and audio recorded by a microphone of the at least one mobile device.
4. The entertainment device of any preceding clause, wherein: the processing circuitry is configured to determine, in dependence on the activity data, an excitement level for the user; and the processing circuitry is configured to control, based on the excitement level, the at least one aspect of the game state.
5. The entertainment device of clause 4, wherein: the processing circuitry is configured to control the at least one aspect of the game state to complement or contrast the excitement level determined for the user; the communication circuitry is configured to receive input data indicative of a user input; and the processing circuitry is configured to: determine, based on the input data, a selection made by a user; and determine, based on the selection made by the user, whether to modify the processing of the game to complement the excitement level or to contrast the excitement level.
6. The entertainment device of clause 4 or clause 5, wherein: the activity data comprises biometric data relating to the one or more activities performed by the user, the biometric data indicating at least one of: an average heart rate of the user over a given period of time; and a number of times that the user's heart rate exceeded a given threshold heart rate over the given period of time; and the processing circuitry is configured to determine, in dependence on the biometric data, the excitement level for the user.
7. The entertainment device of any preceding clause, wherein the processing circuitry is configured to control, as the at least one aspect of the game state, at least one of: selection of the game to be processed; selection of a difficulty level of the game; generation of audio to be played during playing of the game; generation of images to be displayed during playing of the game.
8. The entertainment device of any preceding clause, wherein: the at least one aspect of the game state comprises selection, from amongst a plurality of games, of the game to be processed; and the processing circuitry is configured to select the game to be processed in dependence on the activity data recorded by the at least one mobile device and a classification of each of the plurality of games.
9. The entertainment device of clause 8, comprising access circuitry to obtain, from a storage structure, historic biometric data associated with each of the plurality of games, wherein the processing circuitry is configured to classify each of the plurality of games in dependence on the historic biometric data associated with that game.
10. The entertainment device of clause 9, wherein: the historic biometric data comprises, for each of the plurality of games, historic heart rate data indicative of an average change in heart rate for one or more players playing the game.
11. The entertainment device of any preceding clause, wherein: the activity data comprises information indicative of images captured by a camera of the at least one mobile device; the at least one aspect of the game state comprises generation of images to be displayed during playing of the game; and the processing circuitry is configured to control, in dependence on a result of image classification of the images captured by the camera of the at least one mobile device, the generation of the images to be displayed during playing of the game.
12. The entertainment device of any preceding clause, wherein the processing circuitry is configured to generate, in dependence on the activity data, a welcome screen for display in response to the entertainment device being powered on.
13. An entertainment system, comprising: the entertainment device of any preceding clause; and the at least one mobile device.
14. The entertainment system of clause 14, wherein: the at least one mobile device comprises a mobile device capable of displaying augmented reality (AR) images; the mobile device comprises mobile-device communication circuitry to receive, from the entertainment device, game information associated with a game played by the user; and the mobile device comprises processing circuitry to generate, based on the game information, the AR images for display.
15. A method comprising: identifying a game to be processed; processing a game state of the game; receiving activity data recorded by at least one mobile device, the activity data relating to one or more activities performed by a user; and controlling, in dependence on the received activity data, at least one aspect of the game state.
16. A program for controlling a computer to perform a method according to clause 15.
17. A storage medium storing a program according to clause 16.

1. An entertainment device comprising:
processing circuitry to identify a game to be processed, and to process a game state of the game; and
communication circuitry to receive activity data recorded by at least one mobile device, the activity data relating to one or more activities performed by a user,
wherein the processing circuitry is configured to control, in dependence on the received activity data, at least one aspect of the game state.

2. The entertainment device of claim 1, wherein the processing circuitry is configured to control the at least one aspect of the game state to complement or contrast the one or more activities indicated by the activity data.

3. The entertainment device of claim 1, wherein the activity data comprises information indicative of at least one of:
biometric data of a user;
activity records indicative of physical activities performed by the user;
images captured by a camera of the at least one mobile device; and
audio recorded by a microphone of the at least one mobile device.

4. The entertainment device of claim 1, wherein:
the processing circuitry is configured to determine, in dependence on the activity data, an excitement level for the user; and
the processing circuitry is configured to control, based on the excitement level, the at least one aspect of the game state.

5. The entertainment device of claim 4, wherein:
the processing circuitry is configured to control the at least one aspect of the game state to complement or contrast the excitement level determined for the user;
the communication circuitry is configured to receive input data indicative of a user input; and
the processing circuitry is configured to: determine, based on the input data, a selection made by a user; and determine, based on the selection made by the user, whether to modify the processing of the game to complement the excitement level or to contrast the excitement level.

6. The entertainment device of claim 4, wherein: the activity data comprises biometric data relating to the one or more activities performed by the user, the biometric data indicating at least one of:
an average heart rate of the user over a given period of time; and
a number of times that the user's heart rate exceeded a given threshold heart rate over the given period of time; and
the processing circuitry is configured to determine, in dependence on the biometric data, the excitement level for the user.

7. The entertainment device of claim 1, wherein the processing circuitry is configured to control, as the at least one aspect of the game state, at least one of:
selection of the game to be processed;
selection of a difficulty level of the game;
generation of audio to be played during playing of the game;
generation of images to be displayed during playing of the game.

8. The entertainment device of claim 1, wherein:
the at least one aspect of the game state comprises selection, from amongst a plurality of games, of the game to be processed; and
the processing circuitry is configured to select the game to be processed in dependence on the activity data recorded by the at least one mobile device and a classification of each of the plurality of games.

9. The entertainment device of claim 8, comprising access circuitry to obtain, from a storage structure, historic biometric data associated with each of the plurality of games, wherein the processing circuitry is configured to classify each of the plurality of games in dependence on the historic biometric data associated with that game.

10. The entertainment device of claim 9, wherein: the historic biometric data comprises, for each of the plurality of games, historic heart rate data indicative of an average change in heart rate for one or more players playing the game.

11. The entertainment device of claim 1, wherein:
the activity data comprises information indicative of images captured by a camera of the at least one mobile device;
the at least one aspect of the game state comprises generation of images to be displayed during playing of the game; and
the processing circuitry is configured to control, in dependence on a result of image classification of the images captured by the camera of the at least one mobile device, the generation of the images to be displayed during playing of the game.

12. The entertainment device of claim 1, wherein the processing circuitry is configured to generate, in dependence on the activity data, a welcome screen for display in response to the entertainment device being powered on.

13. An entertainment system, comprising:
an entertainment device comprising
processing circuitry to identify a game to be processed, and to process a game state of the game, and
communication circuitry to receive activity data recorded by at least one mobile device, the activity data relating to one or more activities performed by a user,
wherein the processing circuitry is configured to control, in dependence on the received activity data, at least one aspect of the game state; and
the at least one mobile device.

14. The entertainment system of claim 13, wherein:
the at least one mobile device comprises a mobile device capable of displaying augmented reality (AR) images;
the mobile device comprises mobile-device communication circuitry to receive, from the entertainment device, game information associated with a game played by the user; and
the mobile device comprises processing circuitry to generate, based on the game information, the AR images for display.

15. A method comprising:
identifying a game to be processed;
processing a game state of the game;
receiving activity data recorded by at least one mobile device, the activity data relating to one or more activities performed by a user; and
controlling, in dependence on the received activity data, at least one aspect of the game state.

16. (canceled)

17. A non-transitory computer-readable storage medium storing a program for controlling a computer to perform a method comprising:
identifying a game to be processed;
processing a game state of the game;
receiving activity data recorded by at least one mobile device, the activity data relating to one or more activities performed by a user; and
controlling, in dependence on the received activity data, at least one aspect of the game state.
